(19) United States
(12) Patent Application Publication
(10) Pub. No.: US 2008/0173236 A1
(43) Pub. Date: Jul. 24, 2008

(54) Shuttle Push System For Coating Applicators

(76) Inventors: John P. Wojcik, South Barrington, IL (US); Ghaffar Kazkaz, Rolling Meadows, IL (US)

Correspondence Address: TAYLOR & AUST, P.C.;ILLINOIS TOOL WORKS INC., 142 S. MAIN ST, PO BOX 560, AVILLA, IN, 46710, US

(21) Appl. No.: 11/911,258

(22) PCT Filed: Apr. 10, 2006
(86) PCT No.: PCT/US06/13378

§ 371 Date: Oct. 11, 2007

Related U.S. Application Data
(60) Provisional application No. 60/670,919, filed on Apr. 13, 2005.

(51) Int. Cl. B05B 12/14; B05C 11/02; F16L 55/46; B08B 9/04

(52) U.S. Cl. 118/302; 134/8; 134/166 C

(57) ABSTRACT

A shuttle push system (10) is provided with a displacing object (36) for insertion into a supply tube (26) and removal from the supply at spaced locations. A return tube moves (34) the displacing object between the position at which it is removed (32) from the supply tube and the position (30) at which it is inserted into the supply tube.

### TECHNICAL FIELD

The present invention relates generally to coating applicator systems in which a variety of coatings are applied. More specifically, the invention relates to paint applicators in which color changes are frequent, and cleaning systems for the applicators.

### BACKGROUND ART

In coating applicator systems, it is known to provide interchangeable coating sources so that an applicator can be connected to different sources to provide different coatings on objects. For example, in the manufacture of automobile bodies it is known to provide robotic painting stations in which successive body parts may be painted with any of a large variety of paint colors. Therefore, when painting on one object is complete, it is often necessary to change the color source for the next object to be painted.

A variety of different systems have been both proposed and used for providing multiple sources of coatings, and for switching the applicator connection from one source to another. However, in some such systems, extended lengths of tubing or hoses are used between the applicator and a reservoir from which the coating is dispensed to the applicator; and/or between a coating kitchen and the reservoir or applicator. Whenever a change is made, it is necessary to clean the applicator and all hoses or tubes through which the coating is supplied. Cleaning must be thorough so that subsequent coatings passed through the tubes are not contaminated with residue from previous coatings.

Coating still in the tubes or hoses when an application of coating is complete is wasted when the cleaning function is performed. Even if the hoses or tubes are relatively short, frequent changes result in the waste of a substantial volume of the coating material. If the tubes or hoses are relatively long, waste is even more significant. Accordingly, it has been proposed to use various push-systems for pushing the paint through the tube to the destination during the final moments of coating transfer so that the application or transfer includes most of the material in the tube, and less coating is left in the tube to be wasted.

It also is necessary to perform cleaning and switching functions quickly, preferably in the time it takes to move one coated object from the coating location and to position the next object for coating in the coating location. It has been proposed to use cleaning solvent to push coating through the tubes to the ultimate destination so that initial stages of cleaning are performed even while coating is being completed on the target object. A problem has been experienced in some situations as a result of the relatively high viscosity of the coatings used and the relatively low viscosity of the appropriate solvent. When solvent is used to displace the coating in a tube, the interface between the coating and the solvent following the coating is not well supported. Coating tends to cling to the surfaces of the tube, and the solvent tends to tunnel into the body of coating, advancing in a narrow front through the center of the coating in the tube. As a result, while solvent push systems can be used to displace some of the paint or other coating toward its destination, the intermingling of coating and solvent at the interface between the two liquids prevents substantial portions of the coating from being used.

### DISCLOSURE OF INVENTION

The present invention provides an object, such as a ball, inserted at the interface between coating and solvent in a coating applicator system. The object is pushed through a coating supply tube by the solvent to move coating efficiently through the supply tube to the applicator.

In one aspect thereof, the present invention provides a coating applicator system with an applicator, a coating source and a supply tube establishing flow communication between the applicator and the coating source. A first shuttle box has an inlet connection to the supply tube at a first location, and a second shuttle box has an outlet connection to the supply tube at a second location. A return tube interconnects the first and second shuttle boxes. A displacing object is in selective circulation along a path from the first shuttle box to the second shuttle box via the supply tube and from the second shuttle box to the first shuttle box via the return tube.

In another aspect thereof, the present invention provides a paint supply tube cleaning system with a first shuttle box having an inlet connection to the supply tube at a first location, and a second shuttle box having an outlet connection to the supply tube at a second location in the supply tube remote from the first location. A return tube interconnects the first and second shuttle boxes. A displacing object is injected into the supply tube by the first shuttle box and removed from the supply tube by the second shuttle box, and is transported from the second shuttle box to the first shuttle box via the return tube.

In a still further aspect thereof, the present invention provides a method to clean a coating system having an applicator, a supply system and a coating supply tube in flow communication with and between the applicator and the supply system. The method includes steps of inserting an object into the supply tube near the supply system; pushing the object through the supply tube while operating the applicator for at least a part of the time involved during the pushing step; removing the object from the supply tube near the applicator; and moving the object from the second location to the first location via a return tube.

An advantage of the present invention is efficient cleaning of a supply tube for coating between a coating supply source and a coating applicator.

Another advantage of the present invention is providing a system to clean a tube efficiently, with little intermingling between a first fluid in the tube and a cleaning fluid following the first fluid.

Yet another advantage of the present invention is providing rapid cleaning of a coating applicator apparatus by commencing cleaning in upstream portions of the system before application is complete by the applicator.

Other features and advantages of the invention will become apparent to those skilled in the art upon review of the following detailed description, claims and drawings in which like numerals are used to designate like features.

### BRIEF DESCRIPTION OF DRAWINGS

FIG. 1 is a schematic illustration of an applicator system having a shuttle push system in accordance with the present invention;

FIG. 2 is a cross-sectional view of a portion of the shuttle push system shown in FIG. 1;

FIG. 3 is a cross-sectional view similar to that of FIG. 2, but illustrating the portion of the shuttle push system at a different condition of operation;

FIG. 4 is a cross-sectional view of another portion of the shuttle push system shown in FIG. 1; and

FIG. 5 is a cross-sectional view similar to that of FIG. 4, but illustrating the portion of the shuttle push system at a different condition of operation.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### BEST MODE FOR CARRYING OUT THE INVENTION

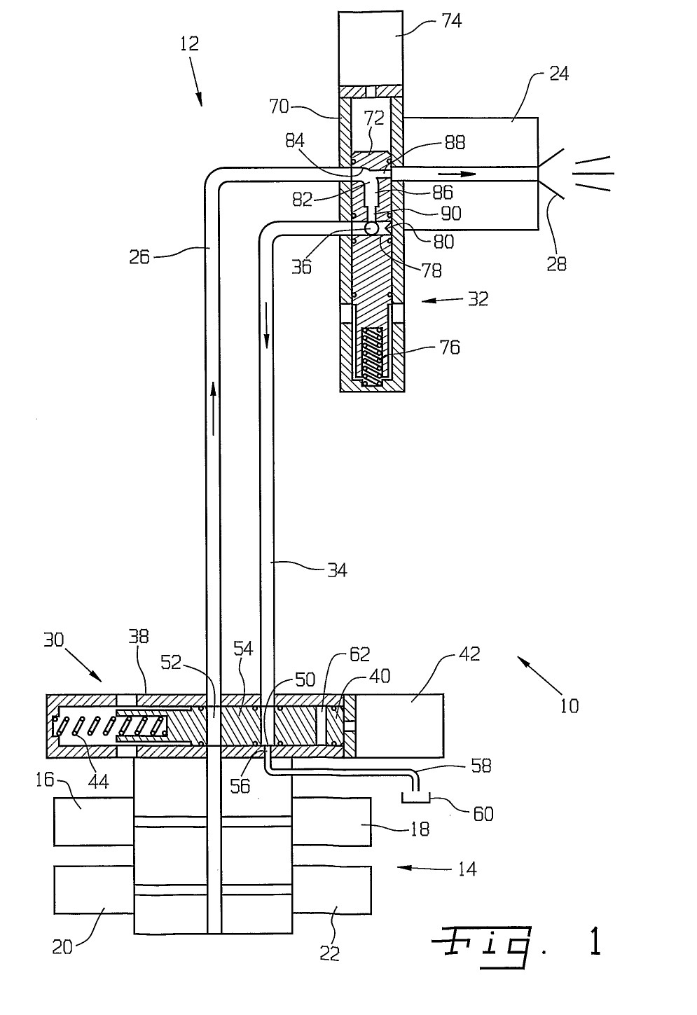

Referring now more specifically to the drawings, FIG. 1 is a schematic illustration of a shuttle system 10 in accordance with the present invention provided in a coating applicator system 12. The applicator system further includes a supply system 14 having a plurality of coating sources 16, 18, a coating solvent source 20 and a pressurized air source 22 for supplying coating, solvent and pressurized air to an applicator 24 via a supply tube 26. Shuttle system 10 works in conjunction with supply tube 26, between supply system 14 and applicator 24.

In the exemplary schematic illustration of FIG. 1 supply system 14 is illustrated with two coating sources 16, 18. However, it should be understood by those skilled in the art that the present invention can be used with a single coating source and with multiple coating sources greater than two. For example, the present invention can be used in automobile body paint booths in which separate individual sources are provided for thirty or more different colors.

The present invention can be utilized with different types of coating, not only paint, and can be used with different types of coating sources alternately connected to supply tube 26 by a coating changer or the like. For example, the present invention can be utilized in an applicator system having a coating kitchen connected via a coating changer to supply tube 26. The present invention also can be used with various types of canister coating sources supplied from a coating kitchen with individual batches of coating sufficient for a single coating operation. Further, while the exemplary embodiment illustrates shuttle system 10 operating between supply system 14 and applicator 24, it should be understood that the present invention can be used between a coating source and a coating destination of various types. Again, by way of example and not limitation, shuttle system 10 can be used between a large volume source and a smaller volume destination, such as an accumulator sufficient for a coating volume to cover a single item. Accordingly, a coating system may include several shuttle systems of the present invention, such as one operating between a coating kitchen or other primary supply source and an accumulator for smaller batches of coating, and another shuttle system operating between the accumulator and the applicator.

Applicator 24 can be of various types, such as, for example, a rotary atomizing applicator having a bell cup 28. Applicator 24 can be a handheld, manually operated sprayer; or applicator 24 can be mounted on a robot for automated maneuvering to apply coating on an object. Further, applicator 24 can be a relatively simple sprayer or a more complex sprayer providing an electric charge on the sprayed coating and shaping air systems for controlling and directing the spray coating toward the object to be coated.

Shuttle system 10 includes a first shuttle box 30 adjacent supply system 14 and a second shuttle box 32 adjacent applicator 24, each first shuttle box 30 and second shuttle box 32 being in selective flow communication with supply tube 26 as will be described in further detail hereinafter. A return tube 34 interconnects first shuttle box 30 and second shuttle box 32. An object 36, such as a ball 36 is selectively circulated along a path including first shuttle box 30 and second shuttle box 32, via supply tube 26 and return tube 34.

Object 36 can be a spherical object, or can be of other shapes to fit snuggly within supply tube 26 so that coating ahead of object 36 is scraped from the interior wall surface of supply tube 26, and so that solvent behind object 36 does not flow past object 36 and intermingle with coating ahead of object 36.

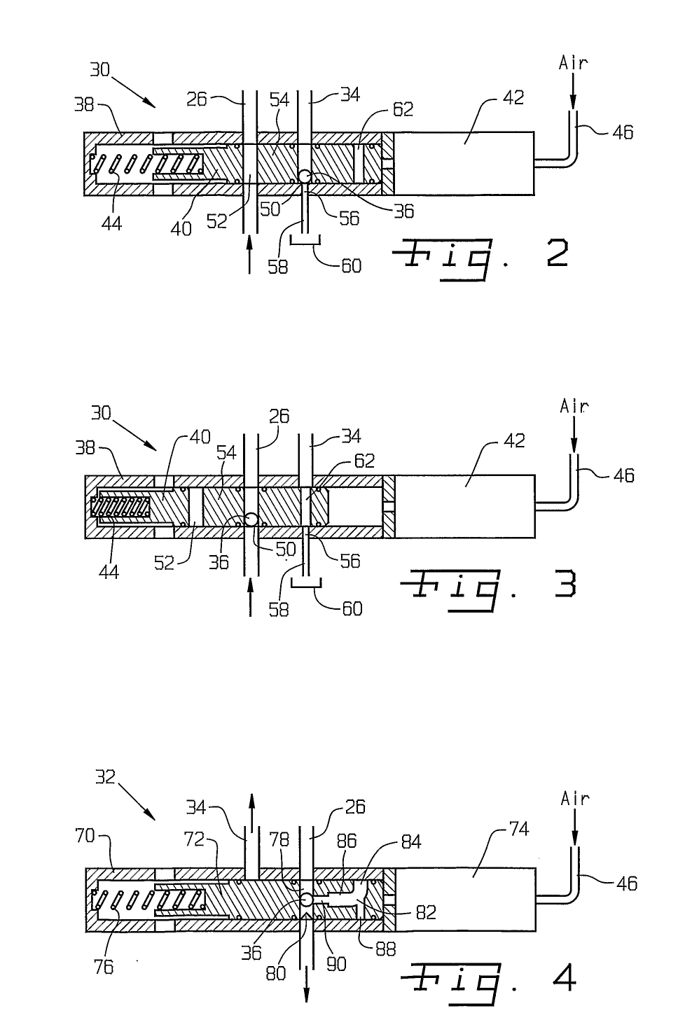

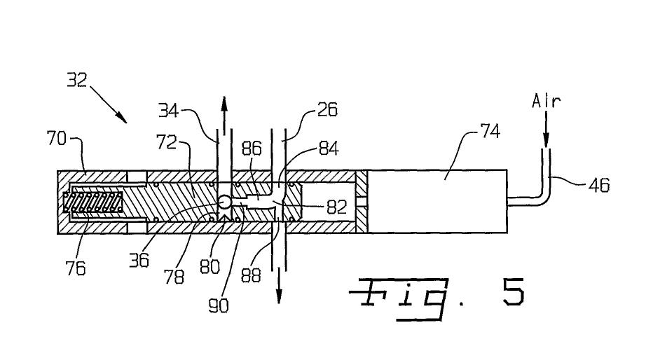

Shuttle box 30 is illustrated in FIGS. 2 and 3, and shuttle box 32 is illustrated in FIGS. 4 and 5. Shuttle box 30 has a housing 38 and a cartridge 40 movable in housing 38. An actuator 42 moves cartridge 40 in housing 38 against the biasing of a spring or other biasing means 44. Actuator 42 can be a pneumatic cylinder, hydraulic cylinder, electric solenoid, stepper motor or other mover capable of repositioning cartridge 40 in housing 38 between a first or receiving position illustrated in FIG. 2 and a second or inserting position illustrated in FIG. 3. In the exemplary embodiment, actuator 42 is an air cylinder connected to an air supply 46.

Cartridge 40 defines a nest 50 for receiving and repositioning object 36 upon movement of cartridge 40 by actuator 42. Nest 50 is open to return tube 34 with shuttle box 30 in the receiving position illustrated in FIG. 2. A supply passage 52 aligns with supply tube 26 when cartridge 40 is in the receiving position illustrated in FIG. 2. A thin wall barrier 54 separates supply passage 52 from nest 50. Thin wall barrier 54 moves transversely through supply tube 26 when object 36 is moved from a received position (shown in FIG. 2) in which object 36 is received from return tube 34, to an inserting position (shown in FIG. 3) in which object 36 is positioned to enter and move through supply tube 26. Thin wall barrier 54 is advantageously thin so as not to interrupt significantly the flow of coating advancing through and entering supply tube 26 when barrier 54 moves across the tube.

A restricted passage 56 communicates with nest 50 and a waste line 58 leading to a dump 60 when shuttle box 30 is in the receiving position illustrated in FIG. 2. Shuttle box 30 further defines a flow through passage 62, for aligning with return tube 34 in the inserting position illustrated in FIG. 3.

The operation of first shuttle box 30 can be understood by comparing the condition of shuttle box 30 illustrated in FIG. 2 to the condition of shuttle box 30 illustrated in FIG. 3. In the receiving position of FIG. 2, nest 50 is aligned with return tube 34 to receive and retain object 36 advancing along return tube 34. Supply passage 52 is aligned between supply system 14 and supply tube 26. Flow through passage 62 is in a non-operative position. Upon movement by actuator 42, cartridge 40 is adjusted in housing 38 such that nest 50 aligns with supply tube 26 and flow through passage 62 aligns with return tube 34 and waste line 58.

Second shuttle box 32 is configured to move object 36 from an end position relative to supply tube 26 into return tube 34 for return to first shuttle box 30. Shuttle box 32 includes a housing 70 having a cartridge 72 movable therein by an actuator 74. A biasing means 76, such as a spring 76, urges cartridge 72 to a capture position (FIG. 4) from a transfer position (FIG. 5).

Cartridge 72 defines a supply passage 78 for the flow of coating therethrough. An orifice 80 captures object 36, preventing passage of object 36 beyond orifice 80 to applicator 24. In an advantageous embodiment, object 36 engaged against orifice 80 prevents flow of fluid past object 36. An L-passage 82 is defined in cartridge 72, and has a through passage 84 and a lateral passage 86. A cleaning line 88 is in substantial alignment with through passage 84, and lateral passage 86 has a distal portion comprising a stepped down passage 90. Cleaning line 88 and step down passage 90 are provided for flow balancing and can be selected advantageously for desired flow rates.

The operation of second shuttle box 32 can be understood by comparing the condition of shuttle box 32 illustrated in FIG. 4 to the condition of shuttle box 32 illustrated in FIG. 5. In the capture position of FIG. 4, fluid such as coating flows through supply passage 78 to applicator 24 unless and until object 36 encounters orifice 80. Flow is then terminated. When actuator 74 adjusts cartridge 72 to the transfer position shown in FIG. 5, through passage 84 and cleaning line 88 are positioned in flow communication between supply tube 26 and applicator 24. Object 36 is positioned to enter return tube 34. Supply tube 26 is also in flow communication with return tube 34 via passage 84, lateral passage 86 and step down passage 90.

During a coating application cycle, such as a painting cycle in a painting applicator system 12, object 36 is stored in first shuttle box 30 in a position away from and out of the flow of paint or other coating through supply tube 26. Thus, object 36 does not interfere with the flow of paint or other coating through supply tube 26. As the end of a painting cycle approaches, coating flow from supply system 14 is terminated and solvent is supplied. Actuator 52 is operated to move object 36 from its stored position into the flow stream of supply tube 26, with cartridge 40 being adjusted from its receiving position illustrated in FIG. 2 to its position for inserting object 36, illustrated in FIG. 3. Object 36 enters supply tube 26 at the transition from or interface of coating and solvent in supply tube 26, with coating downstream of object 36 and solvent upstream of object 36. Object 36 is pushed toward applicator 24 by cleaning solvent behind object 36. This action moves paint or other coating inside supply tube 26 toward applicator 24 to be used as the last volume of coating to be applied. As object 36 arrives in second shuttle box 32, it seats against orifice 80 to completely block the flow of fluid into applicator 24. In this way, all coating in advance of object 36 is pushed into applicator 24, and no fluid behind object 36, essentially solvent, is allowed to enter applicator 24. Coating material waste can be reduced significantly. Object 36 being pushed through supply tube 26 performs some cleaning of the inner surface of supply tube 26. Solvent behind object 36 further cleans supply tube 26 even while coating ahead of object 36 is being applied by applicator 24. Accordingly, cleaning of upstream portions in applicator system 12 commences even before final application of coating is complete, and overall operation and efficiency of applicator system 12 is enhanced.

As the final application process is complete, and object 36 is received at orifice 80, shuttle box 32, via actuator 74, moves object 36 into return tube 34 (FIG. 5). Solvent is pumped through supply tube 26 to clean supply tube 26 and applicator 24, and to move object 36 through return tube 34 to first shuttle box 30. L-passage 82 in the position illustrated in FIG. 5 enables flow from supply tube 26 to applicator 24 via through passage 84 and cleaning line 88. Solvent is supplied to applicator 24 for cleaning applicator 24 of any residue from the coating just applied. Air from pressurized air source 22 can be used to dry surfaces of supply tube 26 and applicator 24 following cleaning by solvent from solvent source 20. Alternating bursts of solvent and air in a so-called “air/solvent chop” can be used for effective cleaning.

L-passage 82 also enables flow from supply tube 26 to return tube 34 via through passage 84, lateral passage 86 and step down passage 90. Object 36 is cleaned in return tube 34 and can also be further cleaned while positioned in shuttle box 30 such that coating does not remain on surfaces of object 36. It may be advantageous to provide return tube 34 slightly larger in diameter than object 36 so that object 36, particularly if configured as a sphere, is allowed to tumble in return tube 34 for more thorough cleaning. After all cleaning is complete, a new paint cycle can begin.

Solvent can be used to clean thin wall barrier 54 and other portions of nest 50 and cartridges 40, 72 as necessary to prevent any contamination of one coating with other coating residues. Appropriate solvent lines can be routed to shuttle boxes 30 and 32 for these purposes.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A coating applicator system, comprising:
an applicator;
a coating source;
a supply tube establishing flow communication between said applicator and said coating source;
a first shuttle box having an inlet connection to said supply tube at a first location;
a second shuttle box having an outlet connection to said supply tube at a second location;
a return tube interconnecting said first and second shuttle boxes; and
a displacing object in selective circulation along a path from said first shuttle box to said second shuttle box via said supply tube and from said second shuttle box to said first shuttle box via said return tube.

2. The coating applicator of claim 1, said first shuttle box having a nest configured to retain said displacing object therein, and an actuator connected to said nest adapted for selectively positioning said nest in a first position for receiving said object from said return tube and in a second position for inserting said object into said supply tube.

3. The coating applicator of claim 1, said second shuttle box having a movable cartridge configured to capture said displacing object therein, and an actuator connected to said cartridge selectively positioning said cartridge in a first position for capturing said displacing object from said supply tube and in a second position for transferring said displacing object into said return tube.

4. The coating applicator of claim 1, said first shuttle box having a nest configured to retain said displacing object therein, and an actuator connected to said nest adapted for selectively positioning said nest in a first position for receiving said object from said return tube and in a second position for inserting said object into said supply tube; and
said second shuttle box having a movable cartridge configured to capture said displacing object therein, and an actuator connected to said cartridge selectively positioning said cartridge in a first position for capturing said displacing object from said supply tube and in a second position for transferring said displacing object into said return tube.

5. The coating applicator system of claim 4, said return tube being of greater diameter than said supply tube.

6. The coating applicator system of claim 5, said displacing object being a sphere.

7. The coating applicator system of claim 1, said displacing object fitting snuggly in said supply tube.

8. A supply tube cleaning system comprising:
a first shuttle box having an inlet connection to the supply tube at a first location;
a second shuttle box having an outlet connection to the supply tube at a second location in the supply tube remote from the first location;
a return tube interconnecting said first and second shuttle boxes; and
a displacing object injected into the supply tube by said first shuttle box, removed from the supply tube by the second shuttle box and transported from said second shuttle box to said first shuttle box via said return tube.

9. The cleaning system of claim 8, said displacing object being a sphere.

10. The cleaning system of claim 8, said return tube having an inner diameter greater than a diameter of said displacing object.

11. The cleaning system of claim 10, said displacing object fitting snuggly in said supply tube.

12. The cleaning system of claim 8, said first shuttle box having a nest configured to retain said displacing object therein, and an actuator connected to said nest adapted for selectively positioning said nest in a first position for receiving said object from said return tube and in a second position for inserting said object into said supply tube.

13. The cleaning system of claim 8, said second shuttle box having a movable cartridge configured to capture said displacing object therein, and an actuator connected to said cartridge selectively positioning said cartridge in a first position for capturing said displacing object from said supply tube and in a second position for transferring said displacing object into said return tube.

14. The cleaning system of claim 8, said first shuttle box having a nest configured to retain said displacing object therein, and an actuator connected to said nest adapted for selectively positioning said nest in a first position for receiving said object from said return tube and in a second position for inserting said object into said supply tube; and
said second shuttle box having a movable cartridge configured to capture said displacing object therein, and an actuator connected to said cartridge selectively positioning said cartridge in a first position for capturing said displacing object from said supply tube and in a second position for transferring said displacing object into said return tube.

15. A method to clean a coating system having an applicator, a supply system and a coating supply tube in flow communication with and between the applicator and the supply system, said method comprising:
inserting an object into the supply tube near the supply system;
pushing the object through the supply tube while operating the applicator for at least a part of the time involved in said pushing;
removing the object from the supply tube near the applicator; and
moving the object from the location of performing said removing step to the location for performing said inserting step via a return tube separate from the supply tube.

16. The method of claim 15, including pushing the object through the supply tube by pumping solvent into the supply tube upstream of the object.

17. The method of claim 15, including moving the object through the return tube by pumping solvent into the return tube.

18. The method of claim 17, including tumbling the object in the return tube while performing said moving step.

19. The method of claim 17, including pushing the object through the supply tube by pumping solvent into the supply tube upstream of the object.

20. The method of claim 19, including tumbling the object in the return tube while performing said moving step.
